(19) United States
(12) Patent Application Publication
(10) Pub. No.: US 2014/0331656 A1
(43) Pub. Date: Nov. 13, 2014

(54) Air Handling Constructions With Turbo-Compounding For Opposed-Piston Engines

(71) Applicant: ACHATES POWER, INC., (US)

(72) Inventors: Nishit Nagar, San Diego, CA (US); Suramya D. Naik, San Diego, CA (US)

(73) Assignee: ACHATES POWER, INC., San Diego, CA (US)

(21) Appl. No.: 13/891,622

(22) Filed: May 10, 2013

(51) Int. Cl. F02B 75/28

(52) U.S. Cl. CPC F02B 75/28
USPC 60/297; 123/51 R

(57) ABSTRACT

An opposed-piston engine has an air handling system equipped with a turbo-compound system that includes a power turbine for producing a rotary output in response to a flow of exhaust gas flowing into the turbine. The rotary output is connected to a crankshaft or other rotating element of the opposed-piston engine for converting some of the exhaust gas energy into mechanical energy supplied to the crankshaft.

### RELATED APPLICATIONS/PRIORITY

This application contains subject matter related to that of the following commonly-assigned applications: U.S. application Ser. No. 13/068,679, filed May 16, 2011; PCT application US2013/026737, filed Feb. 19, 2013; and U.S. application Ser. No. 13/782,802, filed Mar. 1, 2013.

### BACKGROUND

The field is two-stroke cycle internal combustion engines. Particularly, the field relates to uniflow-scavenged, opposed-piston engines with air handling systems that provide pressurized charge air for combustion and process the products of combustion. In some aspects, such air handling systems recirculate and mix exhaust gas with the pressurized charge air in order to lower combustion temperatures.

A two-stroke cycle engine is an internal combustion engine that completes a power cycle with a single complete rotation of a crankshaft and two strokes of a piston connected to the crankshaft. One example of a two-stroke cycle engine is an opposed-piston engine in which two pistons are disposed in opposition in the bore of a cylinder for reciprocating movement in opposing directions. The cylinder has longitudinally-spaced inlet and exhaust ports that are located near respective ends of the cylinder. Each of the opposed pistons controls one of the ports, opening the port as it moves to a bottom center (BC) location, and closing the port as it moves from BC toward a top center (TC) location. One of the ports provides passage of the products of combustion out of the bore, the other serves to admit charge air into the bore; these are respectively termed the “exhaust” and “intake” ports.

In FIG. 1A, a two-stroke cycle internal combustion engine is embodied by an opposed-piston engine 49 having at least one ported cylinder 50. For example, the engine may have one ported cylinder, two ported cylinders, three ported cylinders, or four or more ported cylinders. Each cylinder 50 has a bore 52 and exhaust and intake ports 54 and 56 formed or machined in respective ends of a cylinder wall. Each of the exhaust and intake ports 54 and 56 includes one or more circumferential arrays of openings in which adjacent openings are separated by a solid bridge. In some descriptions, each opening is referred to as a “port”; however, the construction of a circumferential array of such “ports” is no different than the port constructions shown in FIG. 1A. In the example shown, the engine 49 further includes two crankshafts 71 and 72. The exhaust and intake pistons 60 and 62 are slidably disposed in the bore 52 with their end surfaces 61 and 63 opposing one another. The exhaust pistons 60 are coupled to the crankshaft 71, and the intake pistons are coupled to the crankshaft 72.

As the pistons 60 and 62 of a cylinder 50 near TC, a combustion chamber is defined in the bore 52 between the end surfaces 61 and 63 of the pistons. Fuel is injected directly into the combustion chamber through at least one fuel injector nozzle 100 positioned in an opening through the sidewall of a cylinder 50.

With further reference to FIG. 1A, the engine 49 includes an air handling system 51 that manages the transport of charge air provided to, and exhaust gas produced by, the engine 49. A representative air handling system construction includes a charge air subsystem and an exhaust subsystem. In the air handling system 51, the charge air subsystem includes a charge air source that receives intake air and processes it into charge air, a charge air channel coupled to the charge air source through which charge air is transported to the at least one intake port of the engine, and at least one air cooler in the charge air channel that is coupled to receive and cool the charge air (or a mixture of gasses including charge air) before delivery to the intake port or ports of the engine. Such a cooler can comprise an air-to-liquid and/or an air-to-air device, or another cooling device. The exhaust subsystem includes an exhaust channel that transports exhaust products from exhaust ports of the engine for delivery to other exhaust components.

With further reference to FIG. 1A, the air handling system 51 includes a turbocharger 120 with a turbine 121 and a compressor 122 that rotate on a common shaft 123. The turbine 121 is coupled to the exhaust subsystem and the compressor 122 is coupled to the charge air subsystem. The turbocharger 120 extracts energy from exhaust gas that exits the exhaust ports 54 and flows into an exhaust channel 124 directly from the exhaust ports 54, or from an exhaust manifold 125 that collects exhaust gasses output through the exhaust ports 54. In this regard, the turbine 121 is rotated by exhaust gas passing through it. This rotates the compressor 122, causing it to generate charge air by compressing intake air. The charge air subsystem includes a supercharger 110. The charge air output by the compressor 122 flows through a charge air channel 126 to a cooler 127, whence it is pumped by the supercharger 110 to the intake ports. Air compressed by the supercharger 110 can be output through a cooler 129 to an intake manifold 130. The intake ports 56 receive charge air pumped by the supercharger 110, through the intake manifold 130. Preferably, in multi-cylinder opposed-piston engines, the intake manifold 130 is constituted of an intake plenum that communicates with the intake ports 56 of all cylinders 50.

The air handling system shown in FIG. 1A is constructed to reduce NOx emissions produced by combustion by recirculating exhaust gas through the ported cylinders of the engine. The recirculated exhaust gas is mixed with charge air to lower peak combustion temperatures, which lowers NOx emissions. This process is referred to as exhaust gas recirculation (“EGR”). The EGR construction shown utilizes exhaust gasses transported via an EGR loop external to the cylinder into the incoming stream of fresh intake air in the charge air subsystem. The recirculated gas flows through a conduit 131 under the control of a valve 138 (this valve may also be referred to as the “EGR valve”).

An example of a specific EGR loop construction (which is not intended to be limiting) is the high pressure configuration illustrated in FIG. 1B. In this regard, a high pressure EGR loop circulates exhaust gas obtained from a source upstream of the input to the turbine 121 to a mixing point downstream of the output of the compressor 122. In this EGR loop, the conduit 131 and the EGR valve 138 shunt a portion of the exhaust gas from the exhaust manifold 125 to be mixed with charge air output by the compressor 122 into the conduit 126. If no exhaust/air mixing is required the valve 138 is fully shut and charge air with no exhaust gas is delivered to the cylinders. As the valve 138 is increasingly opened, an increasing amount of exhaust gas is mixed into the charge air. Conversely, from an open state, as the valve 138 is increasingly closed, a decreasing amount of exhaust gas is mixed into the charge air. This loop subjects the recirculated exhaust gas to the cooling effects of the two coolers 127 and 129. If less cooling is merited, the exhaust gas portion can be shunted around the cooler 127 to the input of the supercharger 110; this alternative subjects the exhaust gas portion to cooling by only the charge air cooler 129. A dedicated EGR cooler that cools only exhaust gas can be incorporated into the conduit 131, in series with the valve 138, or in series with the output port of the valve 138 and the input to the supercharger 110.

As per FIG. 1B, a control mechanization to operate the air handling system of a two-stroke cycle opposed-piston engine includes an ECU 149. The ECU controls the amount of exhaust gas mixed with the pressurized charge air in response to specified engine operating conditions by automatically operating the valves 138 and 139 (and, possibly other valves), the supercharger 110, if a multi-speed or variable speed device is used, and the turbo-charger 120, if a variable-geometry device is used. Of course, operation of valves and associated elements used for EGR can include any one or more of electrical, pneumatic, mechanical, and hydraulic actuating operations. For fast, precise automatic operation, it is preferred that the valves be high-speed, computer-controlled devices with continuously-variable settings. Each valve has a state in which it is open (to some setting controlled by the ECU 149) to allow gas to flow through it, and a state in which it is closed to block gas from flowing through it.

In a two-stroke cycle opposed-piston such as is illustrated in FIGS. 1A and 1B, the supercharger is used to create a positive pressure differential across the engine in order to drive the airflow and EGR flow. In addition to supercharger, a turbocharger is used to extract some of the exhaust gas energy heat for driving the compressor on the intake side so as to increase the density of the air entering the supercharger, thus reducing the volume flow and pressure ratio through the supercharger. These air handling constructions for two-stroke cycle opposed-piston engines have emphasized positive objectives such as management and effective delivery of charge air and/or control of the transport and mixing of exhaust gas in the charge air delivered for combustion.

However, as the designs of opposed-piston engines continue to evolve for applications in modern transportation systems, air handling systems for those engines must increasingly contribute to improved performance. Accordingly, it is desirable to equip opposed-piston engines with improved air handling constructions that reduce fuel consumption, improve transient response and controllability in the face of changing operating conditions, and improve external EGR driving capability, without increasing mechanical loads on the engine.

### SUMMARY

A two-stroke cycle opposed-piston engine has an air handling system equipped with a turbo-compound system. In this regard, a turbo-compound system includes a blowdown turbine (also called a “blowdown power turbine”) that produces a rotary-mechanical output in response to a flow of exhaust gas flowing into the turbine. The rotary-mechanical output is coupled to a rotating element of the engine. The turbo-compounding system recovers energy from the exhaust gas and couples the recovered energy back into the engine, thereby reducing the engine's specific fuel consumption.

In some aspects, the rotary-mechanical output is coupled to an interlinked crankshaft system of the engine; in other aspects, the rotary-mechanical output is coupled to a crankshaft of the engine; in yet other aspects, rotary-mechanical output is coupled to an electrical converter of the engine.

In some aspects, the air handling system includes both a turbocharger and supercharger, and exhaust gas is provided to the blowdown turbine in parallel with the turbocharger input. In some other aspects, the blowdown turbine is connected in series with the turbine output of the turbocharger.

In some aspects, the air handling system includes a supercharger but no turbocharger. In these cases, the blowdown turbine receives the flow of exhaust gas in parallel with the EGR loop.

In some further aspects, the air handling system includes a supercharger but no turbocharger and no EGR loop. In these cases, the power turbine receives the entire flow of exhaust gas.

### BRIEF DESCRIPTION OF THE DRAWINGS

FIG. 1A is a diagram of an opposed-piston engine equipped with an air handling system with EGR and is properly labeled “Prior Art”.

FIG. 1B is a schematic drawing illustrating a control mechanization for regulation of an air handling system in an opposed-piston engine.

FIG. 2 is a schematic drawing illustrating an opposed-piston engine with a first air handling system construction including a first arrangement of a turbo-compound system.

FIG. 3 is a schematic drawing illustrating an opposed-piston engine with the first air handling system construction including a second arrangement of a turbo-compound system.

FIG. 4 is a schematic drawing illustrating an opposed-piston engine with the first air handling system construction including a third arrangement of a turbo-compound system.

FIG. 5 is a schematic drawing illustrating an opposed-piston engine with the first air handling system construction including a fourth arrangement of a turbo-compound system.

FIG. 6 is a schematic drawing illustrating an opposed-piston with the first air handling system construction including a fifth arrangement of a turbo-compound system.

FIG. 7 is a schematic drawing illustrating an opposed-piston engine with the first air handling system construction including a sixth arrangement of a turbo-compound system.

FIG. 8 is a schematic drawing illustrating an opposed-piston engine with a second air handling system construction including a first arrangement of a turbo-compound system.

FIG. 9 is a schematic drawing illustrating an opposed-piston engine with the second air handling system construction including a second arrangement of a turbo-compound system.

FIG. 10 is a schematic drawing illustrating an opposed-piston engine with a third air handling system construction including a turbo-compound system.

FIG. 11 is a side elevation view of an arrangement of cylinders, pistons, and crankshafts in an opposed-piston engine equipped with a turbo-compound system.

### DETAILED DESCRIPTION OF PREFERRED EMBODIMENTS

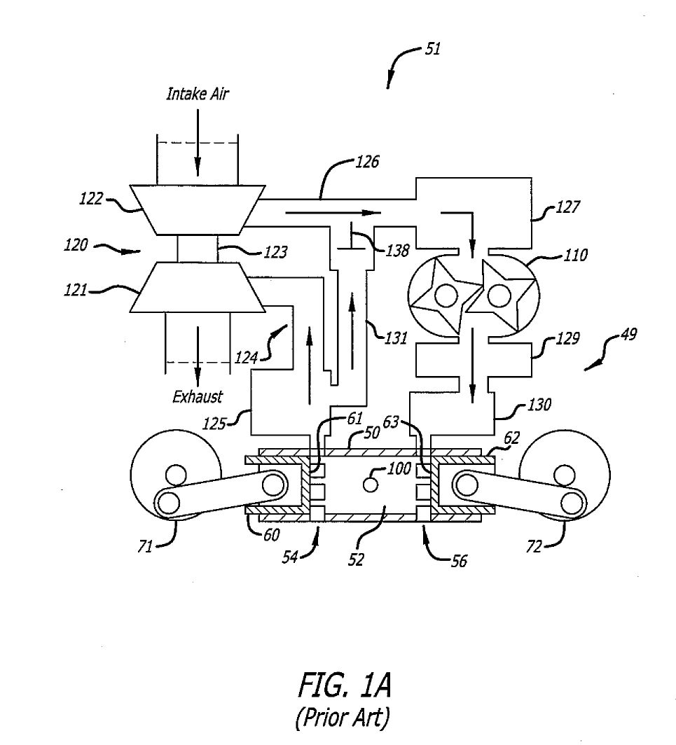

Various different air handling system constructions for a two-stroke cycle opposed-piston engine are described, all of which use a turbo-compound system in combination with a supercharger. For example, in FIG. 1B, the air handling system of the two-stroke cycle opposed-piston engine is equipped with the supercharger 110 and a blowdown turbine 210 that receives some portion of the exhaust gas flowing in the conduit 124 and produces a rotary-mechanical output. In some aspects, such air handling system constructions may include a turbocharger. In any case, the turbo-compound system converts exhaust energy into rotary-mechanical power that is coupled back into a rotating element of the engine, thus reducing the fuel required to generate desired engine power.

In some aspects, depending on operating conditions and selection of components, the combined efficiency of a turbo-compound system together with a turbocharger/supercharger combination has the potential to be greater than the efficiency of an air handling system with only a turbocharger/supercharger combination.

Preferably, the turbo-compound system is equipped with a bypass valve to regulate the flow of exhaust gas through the blowdown turbine, which can be useful in controlling the exhaust pressure of the engine, an important control parameter. Such regulation is also useful to control the mass flow through, or the pressure drop across, the engine and thus the speed of the turbocharger turbine. The ability to increase the exhaust pressure by regulating the flow of exhaust gas through the blowdown turbine can also help increase the external EGR driving pressure difference, thus giving better control of engine emissions. In the air handling constructions to be described in detail, the bypass valve is a computer controlled device that is connected to an air handling system control mechanization operable to control air handling system components as described above in connection with FIG. 1B in response to air management inputs and engine operating conditions.

In those air handling constructions including a turbocharger and a supercharger, the blowdown turbine is situated in the exhaust channel in series with, or parallel to, the turbocharger turbine. In some aspects, the rotary mechanical output produced by the blowdown turbine is coupled to an engine gear train, a supercharger driving gear, or an electrical energy device.

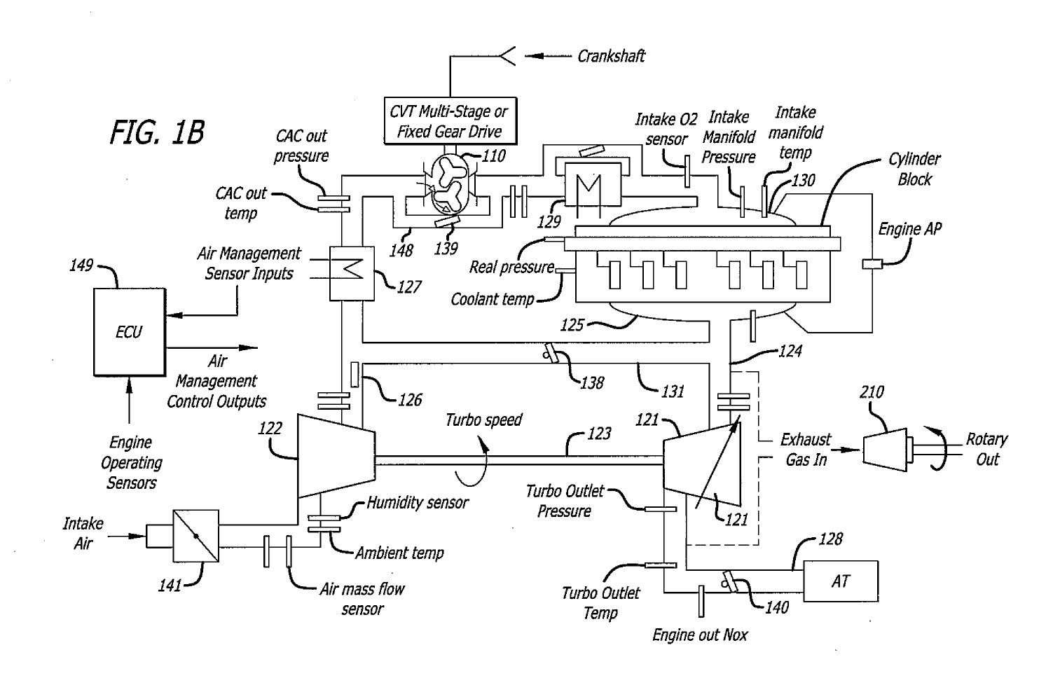

With reference to FIGS. 2, 3, and 4, an air handling system such as that illustrated in FIGS. 1A and 1B is equipped with a turbo-compounding system 200 including a blowdown turbine 210 having a turbine input 211, a turbine output 212, and a rotary-mechanical output 213. The blowdown turbine 210 can be an axial-flow or a radial-flow device. The turbine input 211 is coupled to the output of the turbine 121. The turbine output 212 is coupled to an exhaust output channel 215. Preferably, the exhaust output channel 215 includes one or more after treatment (AT) devices through which exhaust gas flows out of the engine. The blowdown turbine is shunted by a bypass valve 220 connected between the turbine input 211 and the turbine output 212. The supercharger 110 is driven by the interlinked crankshaft system 250 via a gear 251.

As per FIG. 2, the rotary-mechanical output 213 of the blowdown turbine 210 is coupled via a fluidic coupling 214 to a rotating element of the engine 49. In some aspects the rotating element is an element of an interlinked crankshaft system 250 with which the crankshafts 71 and 72 are coupled. Preferably, the rotating element is one of the crankshafts 71 and 72.

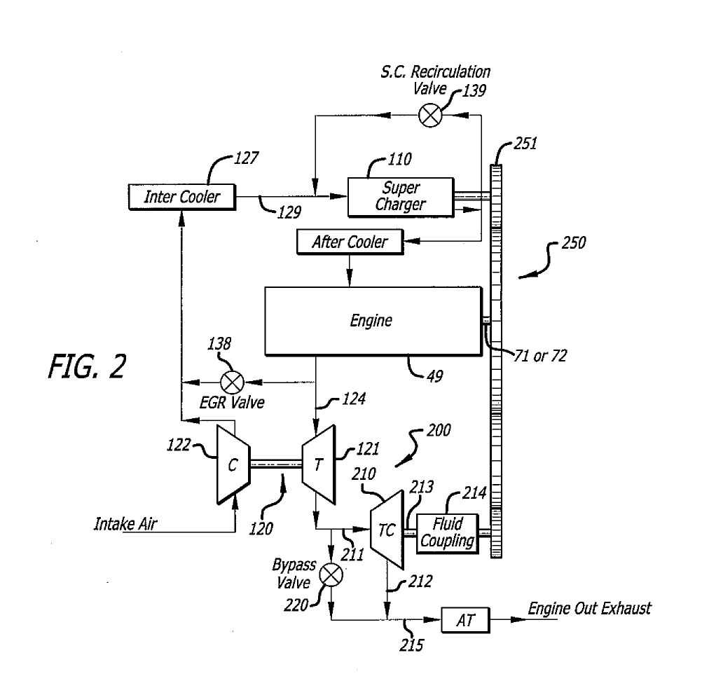

With reference to FIG. 3, the air handling system is constructed in the same manner as in FIG. 2, except that the rotary-mechanical output 213 of the blowdown turbine 210 is coupled directly by a gear 252 to the gear 251 that drives the supercharger 110.

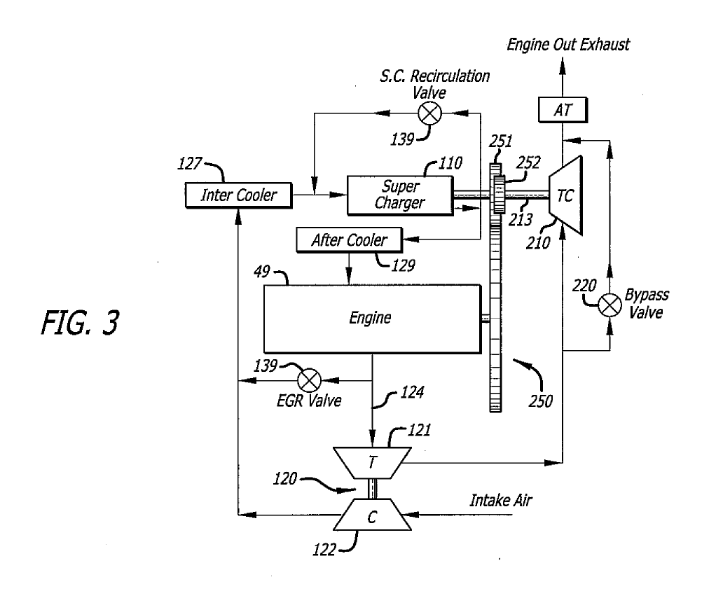

With reference to FIG. 4, the air handling system is constructed in the same manner as in FIG. 2, except that the rotary-mechanical output 213 of the blowdown turbine 210 is coupled directly by an electrical drive system including a generator 260, a battery 262, and electric motor 263 to directly drive the supercharger 110.

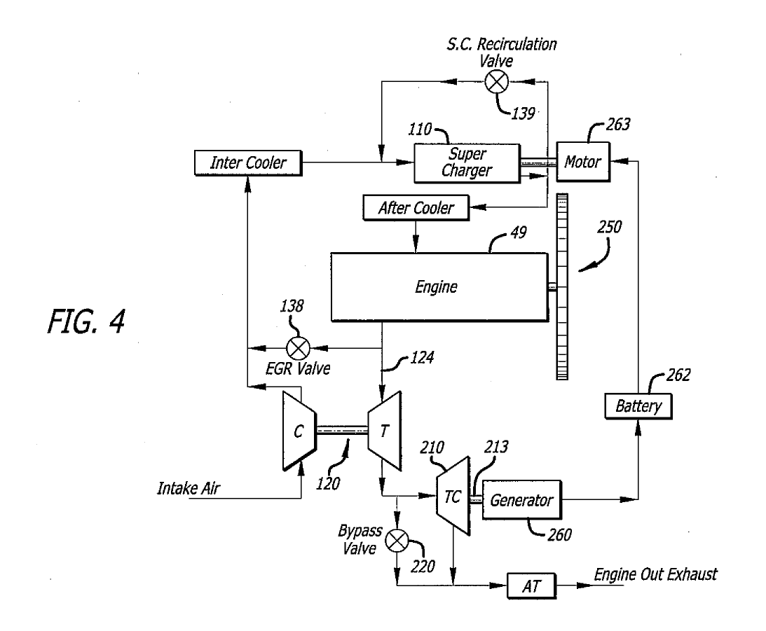

With reference to FIGS. 5, 6, and 7, an air handling system such as that illustrated in FIGS. 1A and 1B is equipped with a turbo-compounding system 200 including a blowdown turbine 210 having a turbine input 211, a turbine output 212, and a rotary-mechanical output 213. The blowdown turbine 210 can be an axial-flow or a radial-flow device. The turbine input 211 is coupled to the exhaust channel 124 in common with the input of the turbine 121. The turbine output 212 is coupled to the exhaust output channel 215 in common with the output of the turbine 121. Thus, the blowdown turbine 210 is coupled to the exhaust channel in parallel with the turbine 121. The bypass valve 220 is coupled in series with the turbine input 211. The supercharger 110 is driven by the interlinked crankshaft system 250 via the gear 251.

In FIGS. 5, 6, and 7, the rotary output 213 of the blowdown turbine is coupled to rotating elements of the engine 49 in the same manner as in FIGS. 2, 3, and 4, respectively.

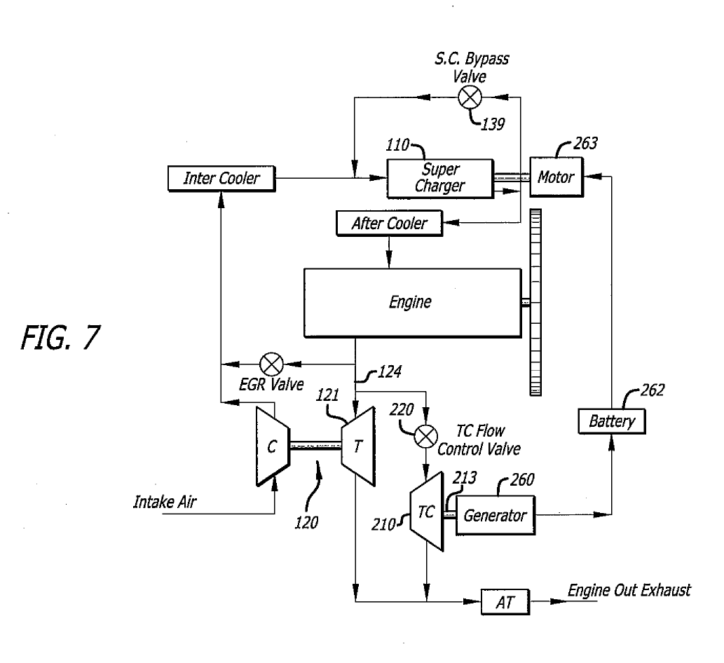

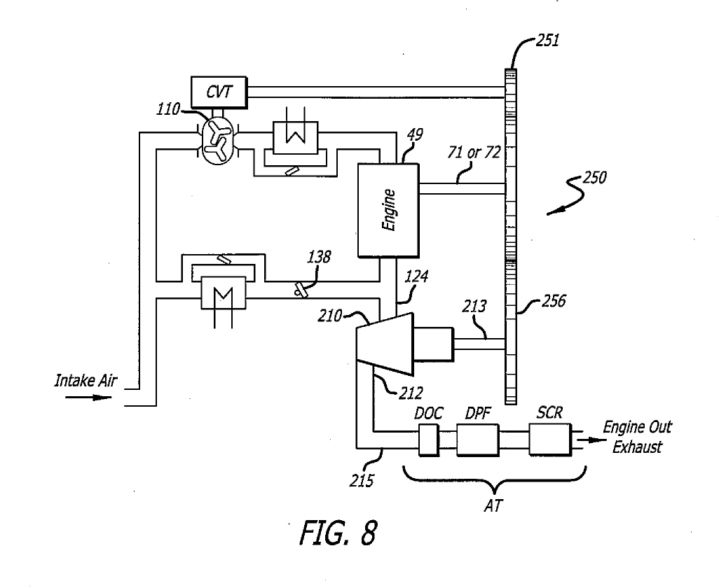

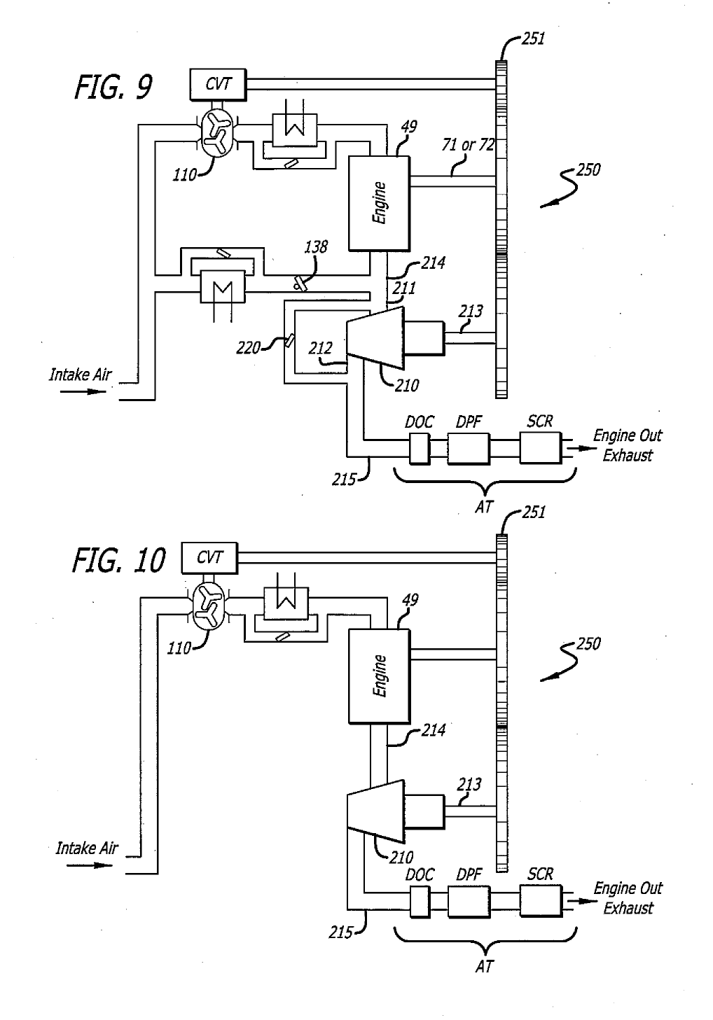

With reference to FIGS. 8, 9, and 10, an air handling system with no turbocharger is equipped with a turbo-compounding system 200 including a blowdown turbine 210 having a turbine input 211, a turbine output 212, and a rotary-mechanical output 213. The blowdown turbine 210 can be an axial-flow or a radial-flow device. The turbine input 211 is coupled to the exhaust channel 124. The turbine output 212 is coupled to the exhaust output channel 215. The supercharger 110 is driven by a continuously variable transmission (CVT) that is rotatably coupled to the interlinked crankshaft system 250 via the gear 251. In FIGS. 8, 9, and 10, the turbine output 213 is coupled to the crankshaft system 250 by a gear 256. In FIG. 9, the bypass valve 220 shunts the input 211 of the blowdown turbine to the exhaust output channel 215. In FIG. 10, the air handling system is without an EGR loop.

Turbo-Compound System with a Supercharger:

In the air handling system constructions of FIGS. 2, 3, 5, and 6, the supercharger work is greater than in the air handling system shown in FIGS. 1A and 1B, but there is a potential to improve the overall system efficiency. This is due the fact that the efficiency of hydraulic coupling 214 or direct mechanical coupling 251 is better than that of a compressor, resulting in better utilization of turbine power, and the supercharger efficiency is better due to an increase in pressure ratio demand (enabled by 214 or 251) for the same amount of mass flow. Those cases in which the rotary mechanical output of the blowdown turbine is coupled directly to a gear driving the supercharger result in a reduction in mechanical loads on the gears connecting the supercharger to the engine crankshafts, thus reducing the weight of the gear train.

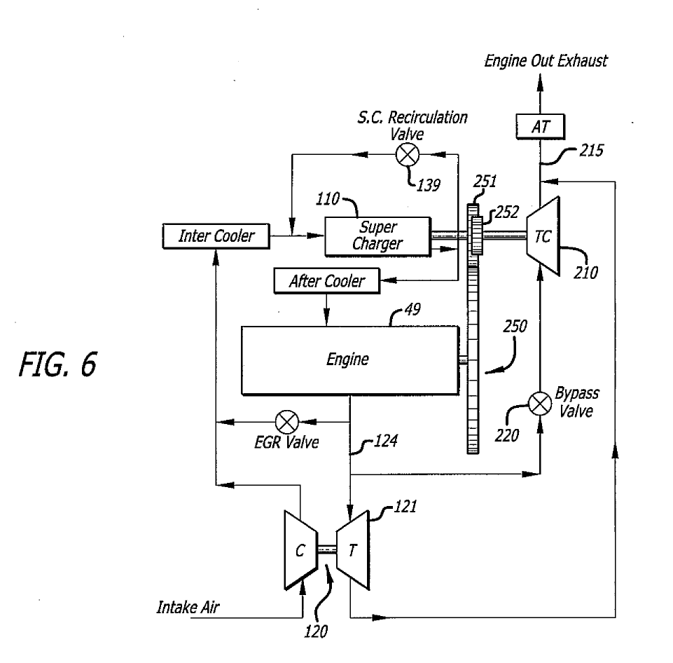

In the air handling system constructions of FIGS. 4 and 7, exhaust gas power is drawn from the blowdown turbine 210 and provided to the supercharger 110 by converting the mechanical energy produced by the blowdown turbine into electrical energy used to drive the supercharger. In these cases the supercharger 110 is driven electrically and is not directly connected to the crankshaft system 250. The turbo-compound system 200 drives the generator 260, which charges the power source 262 for the supercharger motor 263.

Turbo-Compound System with a Turbocharger and a Supercharger:

Series Configuration: The air handling system constructions of FIGS. 2, 3, and 4 place the turbo-compound system 200 in series with the turbocharger turbine 121 so as to harvest additional energy from the exhaust gas before it enters the after treatment devices. In the constructions of FIGS. 2 and 3, the additional energy is added to the crankshaft system 250. In the construction of FIG. 4, the additional energy is applied directly to drive the supercharger 110. The supercharger work requirement is greater in these air-handling constructions than in the conventional case illustrated in FIG. 1A because of lower work from the turbine 121 and compressor 122, but the additional supercharger work is less than the additional power produced by the blowdown turbine 210, resulting in improved overall system efficiency. Connecting the blowdown turbine in series with the turbocharger turbine reduces the chance of compressor choking (when the compressor pressure ratio is low and mass flow is high) when higher power is required during the transient because the mass flow of exhaust gas through the turbocharger turbine is not reduced when the blowdown turbine 210 is bypassed keeping the compressor pressure ratio higher.

Under control of the air handling system control mechanization of FIG. 1B, the bypass valve 220 of the blowdown turbine 210 can be closed to: force the exhaust gas to pass through the blowdown turbine 210, thereby increasing the exhaust pressure; increase the EGR driving pressure difference; and/or prevent the turbine 121 from over speeding when its mass flow and pressure ratios are high. Opening the bypass valve 220 also enables reduction of the exhaust pressure so as to increase the pressure difference across the engine 49, which improves scavenging efficiency in the cylinders, allowing more trapped fresh air in the cylinders to produce more power. The bypass valve 220 can also be opened to reduce the piston temperatures in cases of overheating by improving the scavenging efficiency. Further, the bypass valve 220 can be opened to increase the temperature of the exhaust gases entering into the after treatment, which improves the efficiency of the after treatment devices.

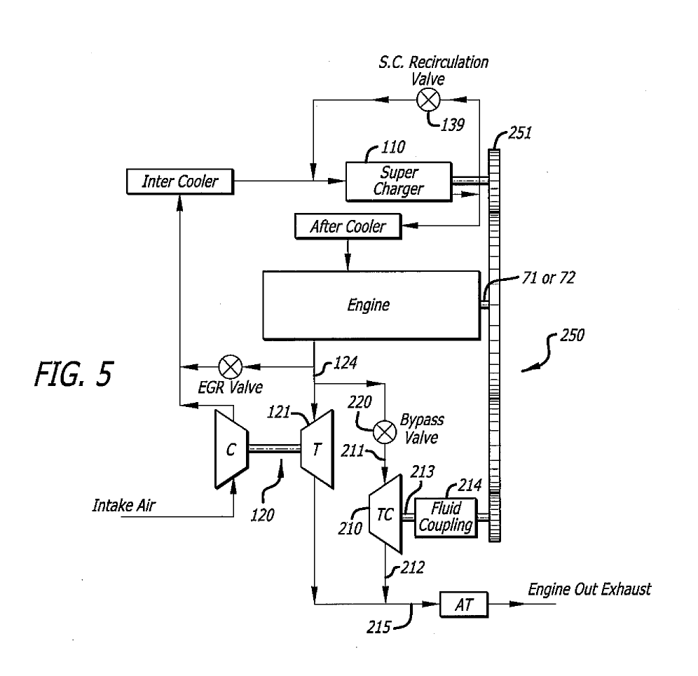

Parallel Configuration: The air handling system constructions of FIGS. 5, 6, and 7 place the turbo-compound system 200 in parallel with the turbocharger turbine 121. The portion of the exhaust gas not diverted for EGR (“engine out exhaust”) is apportioned between the turbine 121 and the blowdown turbine 210. Per FIGS. 5 and 6, the blowdown turbine 210 converts the exhaust energy into mechanical power, but instead of driving the compressor 122, it passes this power to the crankshaft system 250 through 251 or 252. In the construction of FIG. 7, the additional energy is applied directly to drive the supercharger 110. The supercharger work requirement is greater with this air-handling architecture than in the conventional case seen in FIG. 1A because of lower work from the turbine 121 and the compressor 122, but the additional supercharger work is less than the additional power produced by the blowdown turbine 210, resulting in improved overall system efficiency. The bypass valve 220 controlling the flow of exhaust gas can be placed before or after the blowdown turbine 210; in either case the bypass valve/blowdown turbine series combination is parallel to the turbine 121. However, placing the bypass valve 220 after the blowdown turbine 210 reduces the temperature of the exhaust gas entering the valve because of temperature drop through the blowdown turbine, which is an advantage for better durability of the valve. Also, in providing hotter exhaust gas to the blowdown turbine 210 makes more of the exhaust energy available to the blowdown turbine for conversion into mechanical work.

Under control of the air handling system control mechanization of FIG. 1B, the bypass valve 220 of the blowdown turbine 210 can be closed to: reduce the power produced by the blowdown turbine 210; increase the exhaust pressure by forcing the exhaust gas to pass through the turbine 121; and/or increase the EGR driving pressure difference in the case of a high pressure EGR circuit. The same valve 220 can be opened to: reduce the exhaust pressure by increasing the flow through the blowdown turbine 210; increase pressure difference across the engine that improves scavenging efficiency in the cylinders, allowing more trapped fresh air in the cylinders to produce more power; reduce the piston temperatures in case of overheating by improving scavenging efficiency; prevent the turbine 121 from over speeding by reducing the mass flow and pressure difference across it; and/or increase the temperature of the exhaust gases entering into the after treatment, a critical requirement to improve the efficiency of the after treatment devices.

Air Handling System Constructions without a Turbocharger:

The air handling system constructions of FIGS. 8, 9, and 10 do not include a turbocharger. Instead, the crankshaft-driven supercharger 110 generates the positive pressure differential across the engine 49 necessary to drive the flow of charge air and recirculate exhaust gas. Conversion of exhaust gas energy to rotary-mechanical motion is performed exclusively by the blowdown turbine 210. The absence of the turbocharger significantly increases the pumping work of the supercharger 110; therefore, the addition of the blowdown turbine 210 is desirably offsets energy expended in operating the supercharger 100. Addition of the bypass valve 220 (FIG. 9) affords the opportunity to regulate exhaust temperature and pressure under control of the air handling system control mechanization of FIG. 1B. If the application requires variable back pressure or if one fixed blowdown turbine does not meet performance requirements throughout the entire operating range of the engine, then a variable geometry blowdown turbine can be used. Alternately, an exhaust throttle can be used in conjunction with a fixed geometry blowdown turbine to meet backpressure requirements for EGR flow.

After Treatment Considerations:

With reference to FIGS. 2-10, it is possible to have specific after treatment configurations with the above shown air handling constructions based on particular applications. The temperatures of exhaust gas coming out of an exhaust manifold are expected to be lower in a two-stroke cycle opposed-piston engine as compared to conventional four-stroke diesel engines. A baseline arrangement is shown in FIGS. 8-10 wherein a diesel oxidation catalyst device (DOC), a selective catalytic reduction device (SCR), and a diesel particulate filter device (DFR) are arranged in sequence following the output of the blowdown turbine 210. In some aspects, the performance of the SCR can be improved if it is placed between the DOC and DPF, which will assist in faster light-off for the SCR catalyst. The DOC is positioned in front (upstream) of the SCR in order to oxidize some of the NO to NO2 for better SCR performance. This configuration is particularly well suited to after treatment following a fixed-geometry turbocharger with a waste gate or a blowdown turbine without a turbocharger. In other configurations, a DOC-SCR system is placed between the engine 49 and the turbo machinery; a particulate matter reduction system including a DOC-DPF configuration is placed after the turbo machinery. It is also possible to place a DOC-DPF system in front of the turbo machinery. Another approach to control NOx is to use a lean NOx trap (LNT) in conjunction with a non-urea SCR. It should also be noted that the after treatment components—DOC, DPF, SCR, LNT, and, possibly, others—can be placed in various different ways and combinations with a turbocharger and turbo-compound system. Some or all of these devices can be placed between the turbine 121 and the blowdown turbine 210 in the case of a turbo-compound system in series with the turbine 121. In the parallel case (FIGS. 5, 6, and 7) however, the after treatment components have to be either installed before the split of the exhaust mass flow in two branches or after these branches are combined again, in order to provide the chemical treatment to all of the exhaust mass flow.

Coupling Embodiment:

We now describe one embodiment for coupling rotary output of a blowdown turbine to a rotating element of an opposed-piston engine. This embodiment is merely for illustration, and is not meant to be limiting.

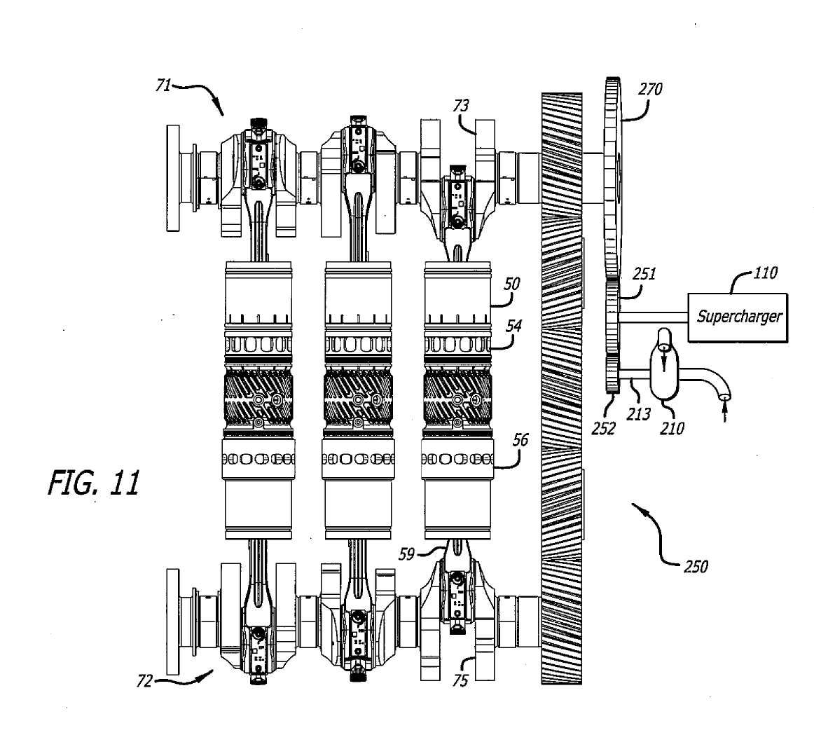

FIG. 11 is a partially schematic representation of an arrangement of cylinders, pistons, and crankshafts in an opposed-piston engine equipped with a blowdown turbine. The figure shows a three-cylinder arrangement, although this is not intended to be limiting; in fact, a blowdown turbine be applied to air handling systems of opposed-piston engines with fewer, or more, cylinders. As per the example of FIG. 1A, the opposed-piston engine includes cylinders 50 (or sleeves or liners), each including exhaust and intake ports 54 and 56. Preferably, the cylinders are fixedly mounted to an engine frame or block (not shown). In this engine construction, a pair of pistons (unseen in this figure) is disposed for opposing reciprocal movement in the bore of each cylinder 50. One piston of each pair is coupled to a respective crank journal 73 of the crankshaft 71 by a connecting rod assembly 57; the other piston is coupled to a respective crank journal 75 of the crankshaft 72 by a connecting rod assembly 59.

An opposed-piston engine corresponding to FIG. 11 includes an interlinked crankshaft system including two rotatably-mounted crankshafts 71 and 72 disposed in a parallel spaced-apart configuration and a gear train assembly 250 linking the crankshafts and coupling them to an output shaft (not shown). Preferably, the crankshafts are co-rotating, although a counter-rotating arrangement can be provided by deletion of one gear from (or addition of another to) the gear train assembly 250. FIG. 11 shows an exemplary embodiment for coupling the blowdown turbine 210 to the crankshaft 71 and the supercharger 110 through gears 252, 251, and 270 (although a belt can be used as well). In this embodiment (which is not intended to be limiting) the blowdown turbine 210 is coupled directly to the supercharger 110 by gears 252 and 251. With this coupling, the gear ratio between the higher speed turbine 210 and the low speed crankshaft 72 can be better managed by having the medium speed supercharger 110 in the middle. For example, the engine speed can be 2000 rpm; supercharger speed can be 5*2000=10000 rpm; and compounded turbine speed can be 8*10000=800000 rpm. This requires one idle gear between engine and compounded turbine to manage such a high ratio of speed; the supercharger 110 in the middle serves as the idle gear. The mechanical losses of the power transmission can be lower since the supercharger 110 is the power consuming device and blowdown turbine 210 is the power producing device. Thus, only the additional supercharger work that cannot be covered by the power producing blowdown turbine has to be transmitted between engine, crankshaft 71, and the supercharger 110. This could mean lower thickness gears 251 and 270 (or using lower strength materials) between the crankshaft and the supercharger. In case the blowdown turbine 210 produces more power than what the supercharger 110 requires, this additional power will get transmitted back to the crankshaft through these gears.

Although air handling constructions have been described with reference to an opposed-engine with two crankshafts, it should be understood that these constructions can be applied to opposed-piston engines with one or more crankshafts. Moreover, various aspects of these constructions can be applied to opposed-piston engines with ported cylinders disposed in opposition, and/or on either side of one or more crankshafts. Accordingly, the protection afforded to these constructions is limited only by the following claims.

1. An opposed-piston engine, comprising:
at least one cylinder with exhaust and intake ports;
a charge air channel to provide charge air to at least one intake port;
an exhaust channel to receive exhaust from at least one exhaust port;
a supercharger operable to pump charge air in the charge air channel; and,
a blowdown turbine having a first turbine input coupled to receive exhaust gas from the exhaust channel and a rotary output drivingly coupled to a rotating element of the engine.

2. The opposed-piston engine of claim 1, in which the engine includes an exhaust gas recirculation (EGR) loop having a loop input coupled to the exhaust channel and a loop output coupled to the charge air channel.

3. The opposed-piston engine of claim 2, in which the rotating element is one of a gear train and an electrical converter.

4. The opposed-piston engine of claim 2, in which the engine includes two crankshafts coupled by a gear train and the rotating element is one of the crankshafts.

5. The opposed-piston engine of claim 2, in which the engine includes a turbocharger with a charge air output coupled to the charge air channel, a second turbine input coupled to the exhaust channel, and a turbine output, and the first turbine input is coupled to the turbine output.

6. The opposed-piston engine of claim 5, in which the rotating element is one of a gear train and an electrical converter.

7. The opposed-piston engine of claim 2, in which the engine includes two crankshafts coupled by a gear train and the rotating element is one of the crankshafts.

8. The opposed-piston engine of claim 2, in which the engine includes a turbocharger with a charge air output coupled to the charge air channel, a second turbine input coupled to the exhaust channel, and a turbine output, and the first turbine input is coupled to the exhaust channel in common with the second turbine input.

9. The opposed-piston engine of claim 8, in which the rotating element is one of a gear train and an electrical converter.

10. The opposed-piston engine of claim 8, in which the engine includes two crankshafts coupled by a gear train and the rotating element is one of the crankshafts.

11. The opposed-piston engine of claim 2, in which the engine includes no turbocharger.

12. The opposed-piston engine of claim 1, in which the engine includes no turbocharger.

13. The opposed-piston engine of claim 12, in which the engine includes no exhaust gas recirculation (EGR) loop.

14. The opposed-piston engine of claim 1, the engine further comprising an after treatment arrangement including one or more of a diesel oxidation catalyst device, a selective catalytic reduction device, and a diesel particulate filter device arranged in a sequence following a turbine output of the blowdown turbine.

15. An opposed-piston engine, comprising:
at least one cylinder with exhaust and intake ports;
a charge air channel to provide charge air to at least one intake port;
an exhaust channel to receive exhaust gas from at least one exhaust port;
a supercharger operable to pump charge air in the charge air channel;
a blowdown turbine having a first turbine input coupled to receive exhaust gas from the exhaust channel and a rotary output drivingly coupled to a rotating element of the engine;
a bypass valve in the exhaust channel operable to regulate a flow of exhaust gas through the blowdown turbine; and,
a control mechanization operable to control the bypass valve in response to air management inputs and engine operating conditions.

16. The opposed-piston engine of claim 15, in which the engine includes an exhaust gas recirculation (EGR) loop having a loop input coupled to the exhaust channel and a loop output coupled to the charge air channel, and the control mechanization is operable to control the supercharger, the EGR loop, and the bypass valve in response to engine operating conditions.

17. The opposed-piston engine of claim 16, in which the rotating element is one of a gear train and an electrical converter.

18. The opposed-piston engine of claim 16, in which the engine includes two crankshafts coupled by a gear train and the rotating element is one of the crankshafts.

19. The opposed-piston engine of claim 16, in which the engine includes a turbocharger with a charge air output coupled to the charge air channel, a second turbine input coupled to the exhaust channel, and a turbine output, and the first turbine input is coupled to the turbine output.

20. The opposed-piston engine of claim 19, in which the rotating element is one of a gear train and an electrical converter.

21. The opposed-piston engine of claim 16, in which the engine includes two crankshafts coupled by a gear train and the rotating element is one of the crankshafts.

22. The opposed-piston engine of claim 16, in which the engine includes a turbocharger with a charge air output coupled to the charge air channel, a second turbine input coupled to the exhaust channel, and a turbine output, and the first turbine input is coupled to the exhaust channel in parallel with the second turbine input.

23. The opposed-piston engine of claim 22, in which the rotating element is one of a gear train and an electrical converter.

24. The opposed-piston engine of claim 22, in which the engine includes two crankshafts coupled by a gear train and the rotating element is one of the crankshafts.

25. The opposed-piston engine of claim 15, the engine further comprising an after treatment arrangement including one or more of a diesel oxidation catalyst device, a selective catalytic reduction device, and a diesel particulate filter device arranged in a sequence following a turbine output of the blowdown turbine.

26. A method of operating an opposed-piston engine, comprising:
generating exhaust gas in at least one ported cylinder of the engine;
transporting exhaust gas from an exhaust port of the ported cylinder through an exhaust channel;
recirculating a portion of the exhaust gas from the exhaust channel;
pressurizing fresh air;
mixing recirculated exhaust gas with the pressurized fresh air to form charge air;
pressurizing the charge air;
providing the charge air through an intake port of the ported cylinder;
converting a portion of the exhaust gas to rotary mechanical motion in a blowdown turbine; and,
coupling the rotary mechanical motion of the blowdown turbine to a rotating element of the engine.

27. The method of claim 26, further comprising controlling engine exhaust pressure by regulating the portion of exhaust gas converted to rotary motion in response to engine air management conditions and engine operating conditions.

28. The method of claim 26, further comprising controlling one of mass flow and pressure drop by regulating the portion of exhaust gas converted to rotary motion in response to engine air management conditions and engine operating conditions.
